(19) United States
(12) Patent Application Publication
(10) Pub. No.: US 2009/0212585 A1
(43) Pub. Date: Aug. 27, 2009

(54) LOADING SPACE ARRANGEMENT

(76) Inventors: Alain Leroy, Diessen-Dettenschwang (DE); Heinz Pschorn, Dachau (DE); Robert Braun, Berg (DE); Dirk Legler, Weil (DE); Michael Koelbl, Neuried (DE); Oliver Vogt, Munich (DE); Thomas Rudolph, Windach (DE); Thomas Jakimenczuk, Höhenkirchen (DE)

Correspondence Address: DICKINSON WRIGHT PLLC, 1875 Eye Street, NW, Suite 1200, WASHINGTON, DC, 20006, US

(21) Appl. No.: 11/908,374

(22) PCT Filed: Mar. 10, 2006
(86) PCT No.: PCT/DE06/00441

§ 371 Date: Jun. 25, 2008

(30) Foreign Application Priority Data
Mar. 11, 2005 (DE) 10-2005-011-679.5

(51) Int. Cl. B60R 5/04

(52) U.S. Cl. 296/37.7

(57) ABSTRACT

The inventive loading arrangement for a motor vehicle comprises a loading space (1) consisting of a loading space surface (2) and a pivotable loading space trap-door (3) provided with a receiving surface (4), wherein said loading space trap-door (3) is pivotable to a loading position, in which the loading space surface (2) and the receiving surface (4) are arranged on the same plane or in a substantially parallel manner and a transporting device is placed in such a way that it is movable between the loading space surface (2) and the receiving surface (4).

The present invention relates to a loading space arrangement for a motor vehicle according to the preamble of claim 1.

A loading space arrangement of the type named previously has already been made known from DE 103 17 539 A1. Here a loading space arrangement is disclosed for a motor vehicle, comprising a loading space with a loading space surface, as well as a pivotable loading space trap-door with a receiving surface, whereby the loading space trap-door can be pivoted into a loading position, in which the loading space surface and the receiving surface are place in a plane or in planes roughly parallel to each other.

However, what is disadvantageous in this regard is the loading of such a loading space arrangement, especially since the loading space trap-door is placed projecting in an opened state before the loading space, and the loaded goods must be lifted over the loading space trap-door into the loading space.

Here the present invention starts and makes it its task to prepare a loading space arrangement that makes it possible to easily load the loading space.

According to the invention, this task is solved by providing a transport device that is placed so as to slide between the area of the loading space surface and the receiving surface. Due to this measure, loaded goods can be deposited on the transport device and, for example, be slid from the loading space trap-door into the interior of the loading space. Naturally, loaded goods can also be slid from the interior of the loading space by means of the transport device into an area of the loading space trap-door.

In an advantageous embodiment of the present invention, provision can be made that the transport device be a flat transport platform. Such a transport device is easy to produce and makes possible a continuous transport surface. Also conceivable, naturally, are alternatively embodied transport devices such as transport grilles.

In advantageous fashion, provision can be made that the transport platform be run in guiding media. Conceivable, for example, are combinations of rollers and rails, but also additional comparable bearing systems that make possible at least sectional linear sliding and/or pivoting of the transport device between the loading space surface and the receiving surface.

In a further advantageous embodiment of the present invention, provision can be made that the guiding media be installed so that the transport platform is transferred into a position which roughly corresponds to the closed position of the loading space trap-door. By this, the transport platform can assume a sealing action, which prevents exhaust gases, for example, from getting into the loading space or passenger compartment of the motor vehicle. Simultaneously the loading space trap-door can remain in an opened state, so that its receiving surface can be used especially to accommodate loads such as crates or also bicycles.

For this, provision can advantageously be made that the surface of the transport platform roughly matches the surface of the loading space trap-door. Correspondingly, an advantageous sealing effect can be achieved, since the opening produced by the pivoting the loading space trap-door upward can be completely closed by the transport platform.

In another advantageous embodiment of the present invention, provision can be made that the loading space trap-door be equipped with a storage area that can be closed by a lid. Tools, warning triangles or gloves can, for example, be stored in such a storage area, by which storage space ultimately is saved in the loading space.

Further features and advantages of the present invention become clear using the description that follows of preferred embodiment examples, with reference to the appended illustrations. Shown are:

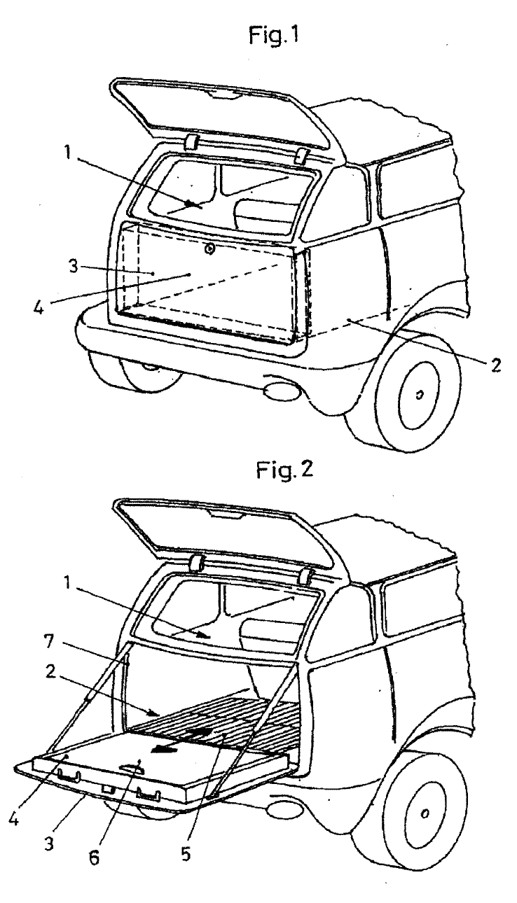

FIG. 1 a loading space arrangement with the loading space trap-door in a closed state;

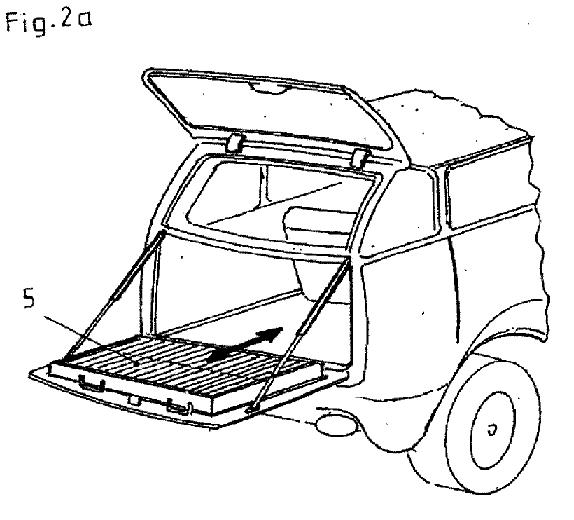

FIG. 2 a loading space arrangement with the loading space trap-door in an opened state (loading space surface and receiving surface aligned), whereby the transport platform was slid onto the loading space surface;

FIG. 2a a loading space arrangement with the loading space trap-door in an opened state (loading space and receiving surface aligned), whereby the transport platform was slid onto the loading space surface;

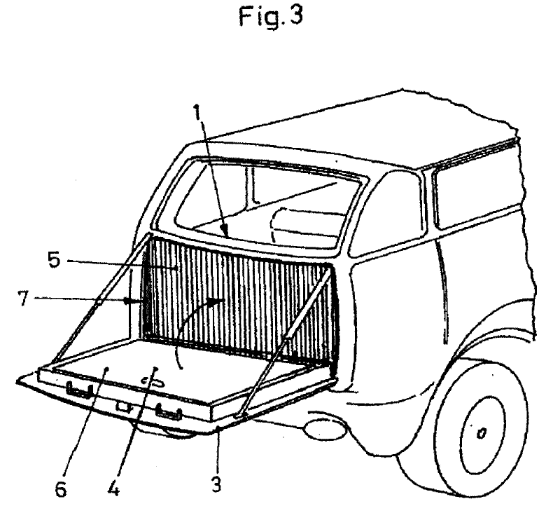

FIG. 3 a loading space arrangement with the loading space trap-door in an opened state (loading space and receiving surface aligned), whereby the transport platform was brought into a vertical position and serves as an exhaust barrier.

Initially reference is made to FIG. 1.

In essence an invention-specific loading space arrangement comprises a loading space 1 with a loading space surface 2, a pivotable loading space trap-door 3 with a receiving surface 4, as well as a transport device that can be slid between the loading space surface 2 and the receiving surface 4.

In the position as per FIG. 1, the loading space arrangement is in a first operating position. In this operating position, the loading space trap-door 3 is closed and the transport device is situated on the loading space surface 2 or the receiving surface 4 as desired. This first operating position represents the regular driving state of the motor vehicle.

In FIG. 2 and FIG. 2a, the loading space arrangement is in a loading position, i.e., the loading space trap-door 3 is swiveled down and loading space surface 2 and receiving space 4 are in a plane. In this position, the transport device, which is embodied here as a flat transport platform 5, can be slid between loading space surface 3 and receiving surface 4. For this, transport platform 5 is guided in suitable (not shown) guidance devices such a rollers and/or rails. Loads can now be set down advantageously onto transport platform 5 and transported, for example, from a position on the loading space trap-door 3 without great effort into loading space 1. Also, naturally, loads can be transported from loading space 1 by sliding transport platform 5 into the area of loading space trap-door 3. For this, provision can also be made that transport platform 5 can be moved via a drive device not shown into predeterminable positions.

An additional operating state is shown in FIG. 3. Here the transport platform 5 is now oriented vertically. The guidance means are placed accordingly for this. In this state, transport platform 5 seals off an opening 7 of loading space 1 created by swiveled-down loading space trap-door 3, so that especially no exhaust gases can penetrate into loading space 1. However, loading space trap-door 3 continues to be open, so that receiving surface 4 can be used especially to accommodate loads like crates or bicycles.

Provision can optionally be made that loading space trap-door 3 be equipped with a storage area that can be closed by a lid 6. Within the storage space, tools, warning triangles or gloves, for example, can be stored.

1. A loading space arrangement for a motor vehicle, comprising
a loading space with a loading space surface, as well as
a pivotable loading space trap-door with a receiving surface, whereby
the loading space trap-door can be pivoted into a loading position in which the loading space surface and the receiving surface are placed in a plane or in planes situated roughly parallel to one another,
characterized in that
a transport device is provided, that is place between an area of the loading space surface and the receiving surface so as to be able to slide.

2. The loading space arrangement of claim 1, characterized in that the transport device is a flat transport platform.

3. The loading space arrangement of claim 1, characterized in that the transport platform is admitted into guidance devices.

4. The loading space arrangement of claim 1, characterized in that the guidance device is set up to transfer the transport platform into a position that corresponds to an opening of loading space with the loading space trap-door opened.

5. The loading space arrangement of claim 1, characterized in that the surface of the transport platform roughly corresponds to the receiving surface of the loading space trap-door.

6. The loading space arrangement of claim 1, characterized in that the loading space trap-door is equipped with a storage area that can be closed by a lid.
